(19) United States
(12) Patent Application Publication
(10) Pub. No.: US 2016/0055590 A1
(43) Pub. Date: Feb. 25, 2016

(54) HEALTH CARE SYSTEM AND METHOD OF OPERATING

(71) Applicant: Thomas James Kirby, Lyndhurst, OH (US)

(72) Inventor: Thomas James Kirby, Lyndhurst, OH (US)

(21) Appl. No.: 14/467,160

(22) Filed: Aug. 25, 2014

(51) Int. Cl. G06Q 40/08; G06Q 30/02

(52) U.S. Cl. CPC G06Q 40/08; G06Q 30/0207

(57) ABSTRACT

A method and system for incentivizing the use of inexpensive health care including receiving an inquiry about a medical procedure desired by a user at a first healthcare provider covered by a health insurance company. The database of the user's health insurance company's server is queried for healthcare providers including the first healthcare provider able to provide the medical procedure and the cost of the medical procedure at each of the healthcare providers. A computerized list of the healthcare providers able to provide the medical procedure at a cost less than the first healthcare provider is generated by the healthcare center's server. A monetary incentive is computed for selecting any of the healthcare providers able to provide the medical procedure at a cost less than the first healthcare provider and the user is provided with the computerized list and the monetary incentive for each.

### TECHNICAL FIELD OF THE INVENTION

The present invention relates to an improved health care system and method of operating the system more particularly to a system for incentivizing a user to use a less expensive health care provider.

### BACKGROUND OF THE INVENTION

Health insurance is insurance against the risk of incurring medical expenses among individuals. By estimating the overall risk of health care and health system expenses, among a targeted group, an insurer can develop a routine finance structure, such as a monthly premium or payroll tax, to ensure that money is available to pay for the health care benefits specified in the insurance agreement. The benefit is administered by a central organization such as a government agency, private business, or not-for-profit entity.

The cost of healthcare has risen above inflation for the last 30 years and is unsustainable for consumers and health care providers alike are facing formidable challenges in managing the changing economic landscape of health care payments. For consumers, health care remains one area of commerce where most people lack the information necessary to ascertain the cost of rendered services. In private plans, a general rule is that consumers are given the freedom to choose healthcare providers, but they are not provided with information to make cost-efficient choices. Healthcare providers generally do not publish their pricing information, which by itself makes it difficult for consumers to make informed decisions. To make things worse, the consumer is not cost conscious as all the services are covered no matter whatever the cost and is usually experiencing time pressure from the presence of some medical condition for which the consumer desires prompt treatment. There is an overall lack of transparency in the cost of healthcare to consumers.

### SUMMARY OF THE INVENTION

According to an embodiment of the present invention, there is disclosed a method for incentivizing the use of inexpensive health care. The method includes receiving an inquiry about a medical procedure desired by a user at a first healthcare provider covered by a health insurance company to a healthcare center's server. The database of the user's health insurance company's server is queried for a plurality of healthcare providers including the first healthcare provider able to provide the medical procedure and the cost of the medical procedure at each of the plurality of healthcare providers. A computerized list of the plurality of healthcare providers able to provide the medical procedure at a cost less than the first healthcare provider is generated by the healthcare center's server. A monetary incentive is computed on the healthcare center's server for selecting any of the healthcare providers on the computerized list able to provide the medical procedure at a cost less than the first healthcare provider and the user is provided with the computerized list of the plurality of the healthcare providers able to provide the medical procedure at a cost less than the first healthcare provider and the monetary incentive for selecting each particular healthcare provider.

According to an embodiment of the present invention, there is disclosed a system for incentivizing the use of inexpensive health care. A healthcare center's server is operative to receive an inquiry about a medical procedure desired by a user at a first healthcare provider covered by a health insurance company. The healthcare center's server is operative to querying the database of the user's health insurance company's server for a plurality of healthcare providers including the first healthcare provider able to provide the medical procedure and the cost of the medical procedure at each of the plurality of healthcare providers. The healthcare center's server is operative to generate a computerized list of the plurality of healthcare providers able to provide the medical procedure at a cost less than the first healthcare provider. The healthcare center's server is operative to compute a monetary incentive on the healthcare center's server for selecting each of the plurality of healthcare providers on the computerized list able to provide the medical procedure at a cost less than the first healthcare provider, to provide the user with the computerized list of the plurality of healthcare providers able to provide the medical procedure at a cost less than the first healthcare provider, and the monetary incentive for selecting each of the plurality of healthcare providers.

Further according to an embodiment of the present invention, there is disclosed a non-transitory program storage device capable by a machine, tangibly embodying a program of instructions executable by the machine to perform a method of incentivizing the use of inexpensive health care. The non-transitory program storage device includes receiving an inquiry about a medical procedure desired by a user at a first healthcare provider covered by a health insurance company to a healthcare center's server. The database of the user's health insurance company's server is queried for a plurality of healthcare providers including the first healthcare provider able to provide the medical procedure and the cost of the medical procedure at each of the plurality of healthcare providers. A computerized list of the plurality of healthcare providers able to provide the medical procedure at a cost less than the first healthcare provider is generated by the healthcare center's server. A monetary incentive is computed on the healthcare center's server for selecting each of the healthcare providers on the computerized list able to provide the medical procedure at a cost less than the first healthcare provider. The user is provided with the computerized list of the plurality of the healthcare providers able to provide the medical procedure at a cost less than the first healthcare provider and the monetary incentive for selecting each particular healthcare provider.

Still further according to another embodiment of the present invention, there is disclosed a method for incentivizing the use of inexpensive health care. The method includes receiving an inquiry about a medical procedure desired by a user covered by a health insurance company to a healthcare center's server. The data base of the user's health insurance company's server is queried for a plurality of healthcare providers able to provide the medical procedure and the cost of the medical procedure at each of the plurality of healthcare providers. A computerized list of the plurality of healthcare providers able to provide the medical procedure and the cost of the medical procedure is generated by the healthcare center's server. A plurality of monetary incentives is computed for each of the plurality of healthcare providers on the computerized list, and the user is provided with the computerized list of the plurality of healthcare providers able to provide the medical procedure and a user monetary incentive for selecting each of the plurality of healthcare providers.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a schematic view of the improved healthcare system, in accordance with the present invention.

FIG. 2 is a schematic view of the communications of the data network to or from computing and mobile computing devices, in accordance with the present invention.

FIG. 3 is a schematic view of a user's interaction with the improved healthcare system, in accordance with the present invention.

FIG. 4 is a schematic view of the network's communication with a health insurance company, in accordance with the present invention.

FIG. 5 is a schematic view of the network's communication with healthcare providers, in accordance with the present invention.

FIG. 6 is a schematic view of the division of incentivized savings distributed by the improved healthcare system, in accordance with the present invention.

FIG. 7 is a schematic view of the general method of utilizing the improved healthcare system, in accordance with the present invention, in accordance with the present invention.

FIG. 8 is a schematic view of a method of a user's interaction with the improved healthcare system, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

Changes in healthcare over the past several years have increasingly affected patients and the decisions they make about their healthcare. Due to the influx and demand for new medical technologies and pharmaceuticals, healthcare costs have skyrocketed. As healthcare costs become an ever-increasing percentage of operating budgets, small to mid-sized corporations that used to provide these benefits are no longer able to afford the rising costs. These employers have abandoned their healthcare benefit plans, or at the very least, have decreased their contribution towards an employee's monthly premium. As such, healthcare is no longer an automatic benefit of employment, and employees are being asked to shoulder an increasing portion of the cost of their health care through higher premiums and deductible. Healthcare consumers are now more in charge of their healthcare decisions from a financial standpoint.

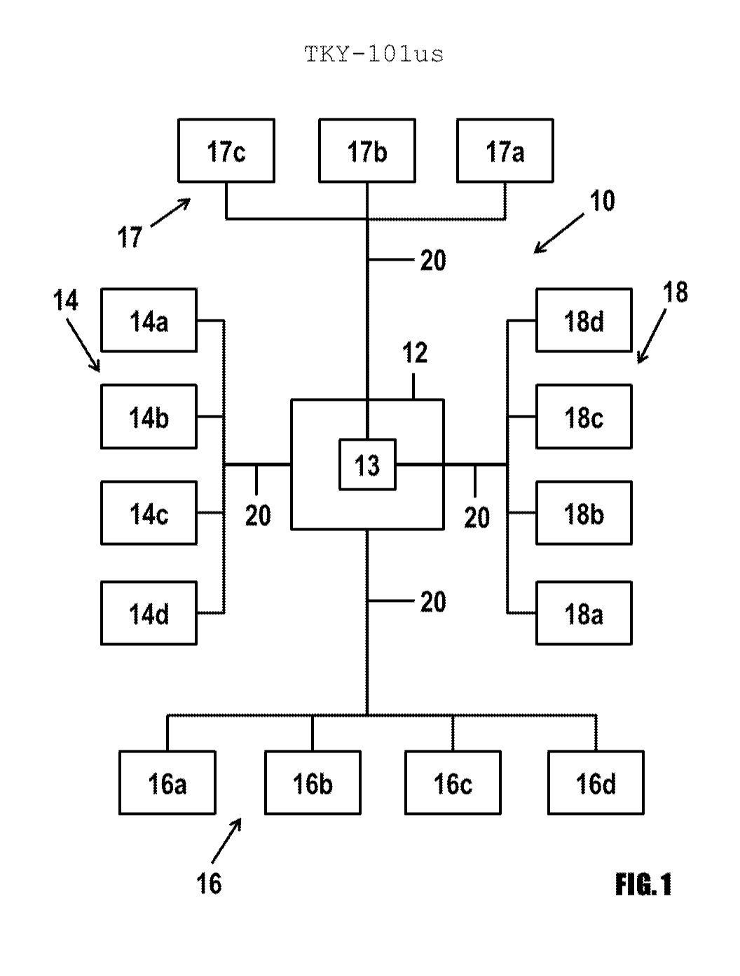

As illustrated in FIG. 1, the improved health care system 10 is designed to price transparency in healthcare so that users can make informed decisions on the most cost-effective care in their immediate area. The improved health care system 10 incentivizes users to select the most cost effective healthcare from a determined list of potential healthcare providers while maintaining quality of care. The improved health care system 10 includes a healthcare center 12 that is interconnected through a server 13 with a plurality of health insurance companies 14, including any number such as 14a, 14b, 14c and 14d (14a-14d), a plurality of healthcare providers 16 including any number such as 16a, 16b, 16c and 16d (16a-16d), and a plurality of patients or users 18 including any number such as 18a, 18b, 18c and 18d (18a-18d) via a data communication network 20. The term user is generally used throughout this specification.

In general terms, healthcare center 12 will gather information on its server 13 from health insurance companies 14a-14d on the different reimbursement rates to healthcare providers 16a-16d for all medical procedures in each state, identifying providers that have the lowest cost for each medical procedure while maintaining excellent quality of care. The healthcare center's server will also gather quality assurance data 17 (complication rates, morbidity, mortality, LOS, patient satisfaction etc.) on its server from any number of sources of quality assurance data 17a-17c, such as for example, Centers for Medicare and Medicaid Services (CMS) 17a, quality data that is reported to the Joint Commission 17b by healthcare providers 16a-16d and information 17c that providers use to burnish the reputations of the plurality of healthcare providers 16 as high quality providers to the public, will also be identified and collected within the healthcare center 12.

Once the reimbursement rates and quality assurance data have been collected on the healthcare center's server from the sources of quality assurance data 17a-17c, all healthcare providers 16 that report outcomes and patient satisfaction scores that are comparable with the other healthcare providers in a predetermined geographical area, will be assembled on a computerized listed. Each of the listed healthcare providers will have a cost rebate to the patient associated with it. The amount of the cost rebate will relate to the cost differential between the user's original healthcare provider and the healthcare provider finally selected by the user 18. If the user chooses the lower cost provider, he/she will be paid for the cash rebate.

The healthcare center's server 13 that is connected to other components of the health care system 10 through a data network 20 and responds to input data from one of the users 18. As is known in the art, the server at the healthcare center 12 includes non-transitory program storage device capable by a machine, tangibly embodying a program of instructions executable by the machine to perform a method of incentivizing the use of inexpensive health care. Further, the server 13 includes computer readable data storage media such as hard disk drives and RAM memory that store program instructions and data. Using such stored programs, the healthcare center 12 can run application programs that respond to input data.

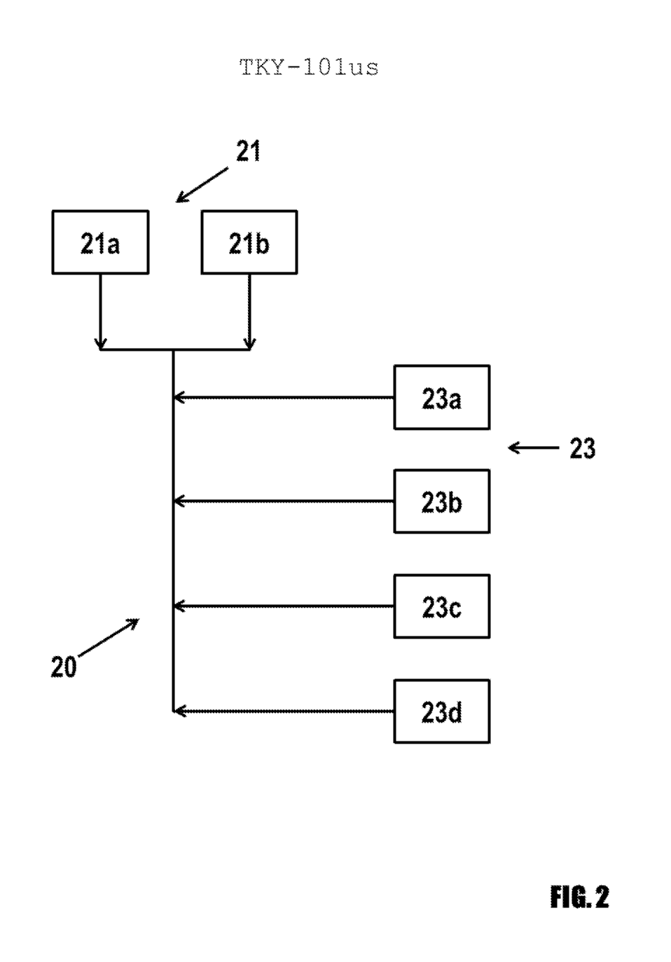

The network 20, as shown in FIG. 2, may be any type of electronically connected group of computers including, for instance, the following networks: Internet, Intranet, Local Area Networks (LAN), Wide Area Networks (WAN) or an interconnected combination of these network types. Obviously, the network 20 includes the Internet, which generally connects a plurality of users in accordance with a client-server model.

As shown in FIG. 2, communications within the data network 20 and to or from the computing and mobile computing devices 21 and 23, respectively, connected to the network may be either wired or wireless. The computing devices 21, such as desktop 21a or laptop computer stations 21b, as well as the mobile computing devices 23, such as a cell phone 23a, a smart phone 23b, a tablet 23c, a PDA 23d, or other mobile communications devices, are capable of sending and receiving data over the wireless network 20. Each of the computing devices 21 as well as mobile communications device 23 may include a processor, network interface circuitry, and memory. In an alternative embodiment, the data network 20 may be presented via a secure virtual private network (VPN) connection.

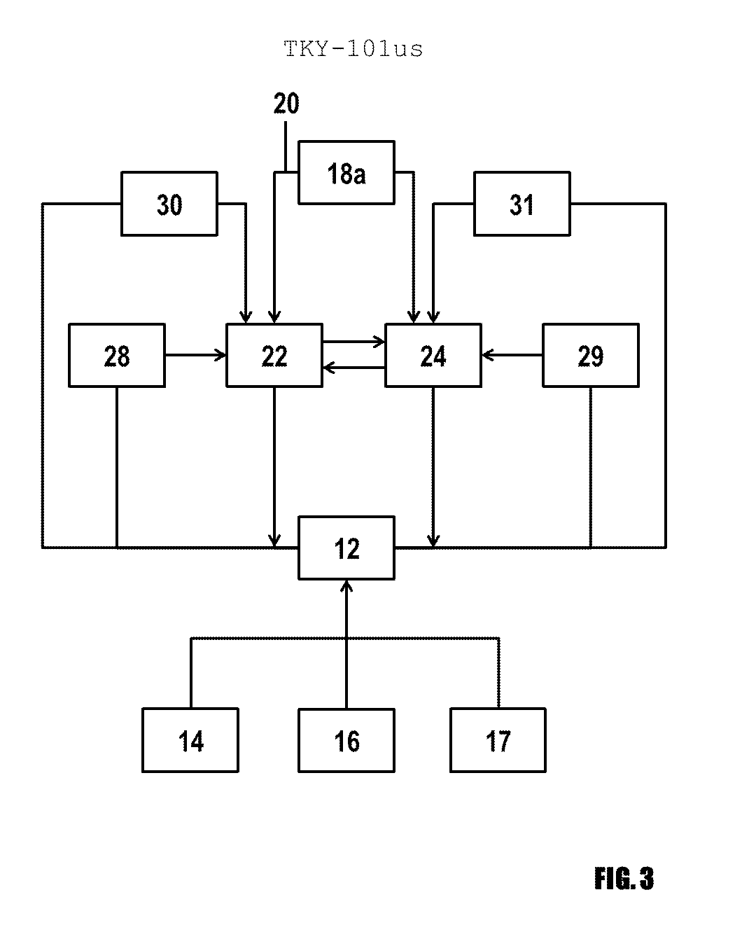

As illustrated in FIG. 3, the user 18a in need of medical care communicates with the data network 20, that is run by the health center's server 13. Typically, this interaction occurs via a website 22 or a mobile application (app) 24. The website 22 may be constructed as an interface that allows the user 18a to select a geographical area, enter a selected medical procedure and a receive list of healthcare providers 16 capable of performing the selected medical procedure, the quality assurance data 17 for each of the listed healthcare providers and the cost of the medical procedure for each of the listed healthcare providers and the rebate associated with each provider. The style choice selected for the website 22 or the mobile app 24 design may include an ability to change the presentation of the look of the website. This may include how items on the website are arranged, colors that are used, and other aspects of the website relating to the overall look of the website. The text choice 26 may include the ability to create text boxes on the website 22 or the mobile app 24 to fill with text that may relate to the healthcare providers 16a-16d. The text choice 26 may allow a user 18a that accesses the website 22 or the mobile app 24 to gain information regarding the healthcare provider 16a-16d or for any other reason that may be apparent to those skilled in the art.

The graphics choices 28 and 29 allows for the addition of graphics to the website 22 or the mobile app 24, respectively, to make the website and/or mobile app more appealing, attractive and/or informative. The graphics 28 and 29 may be saved within the server of healthcare center 12. Further, graphics 28 and 29 may be imported to the website 22 or the mobile app 24 via the healthcare center 12. Photos 30 and 31 may also be added to the website 22 or the mobile app 24, respectively, such as by importing them from a database stored on the healthcare center's server. Alternatively, the healthcare center's server may download graphics directly from the healthcare providers 16 or the health insurance companies 14.

The website 22 or the app 24 will connect with the network 20, which is run by the healthcare center's server. When a user 18a logs on to the website 22 or the app 24 for the first time, the user may be asked to create an account, including creating a unique user name, such as an E-mail address, and a password, which a log-in module within the website 22 can require for secure access to the improved health care system 10. In some embodiments, the website 22 or the app 24 can provide the user 18a a temporary password, or a link to a secure screen where the new user can create and/or change a password. In additional embodiments, the website 22 or the app 24 can require the new user 18a to accept a set of terms and conditions and/or complete a member profile before completing registration.

Further, the user may create a profile within their account on the website 22 or the app 24, including their physical features, such as height and weight, pertinent insurance information, their geographical area, their medical record, the medications that they are currently taking, any relevant family health issues, a window of potential dates for the medical procedure to take place, and any other significant information. It is within the terms of the embodiment that the website 22 and the app 24 are interconnected, such that the information that the user 18a enters into the website 22 is automatically entered into the app 24, and vice versa.

Once the user has logged in to the website 22 or the app 24, he/she will enter the desired medical procedure, their health insurance company 14a and the name of a healthcare provider 16a at which they are planning to have the medical procedure performed.

Each of the listed healthcare providers 16b-16d will have a rebate associated with it whose amount will be related to the cost savings to the health insurance company 14a if the user 18a selects this provider as compared to the healthcare provider 16a at which they were originally planning to use for the medical procedure. If the user 18a accepts one of the listed, less expensive providers 16b-16d, other than the healthcare provider 16a which they were originally planning to use, the network 20 will have their medical record forwarded and any other relevant information to the newly selected healthcare provider and an appointment will be arranged to be seen by the appropriate specialist for evaluation and booking of the medical procedure. Further, once the medical procedure is complete, the health insurance company will send the user 18a a rebate amount equal to a defined percentage of the savings to the health insurance company due to the user selecting a less expensive healthcare provider. It is also within the terms of the present invention for the health insurance company to send the amount due for the rebate to the user and the healthcare center 12 wholly to the health center and the health center can send the amount due to the patient.

Further,a database of the user 18a records is maintained in the server of healthcare center 12 such hat the improved health care system 10 can compile a history for the user including the type of medical procedures performed, quality assurance data patient satisfaction, patient complaints, the total cost of the medical procedure payouts made on his behalf.

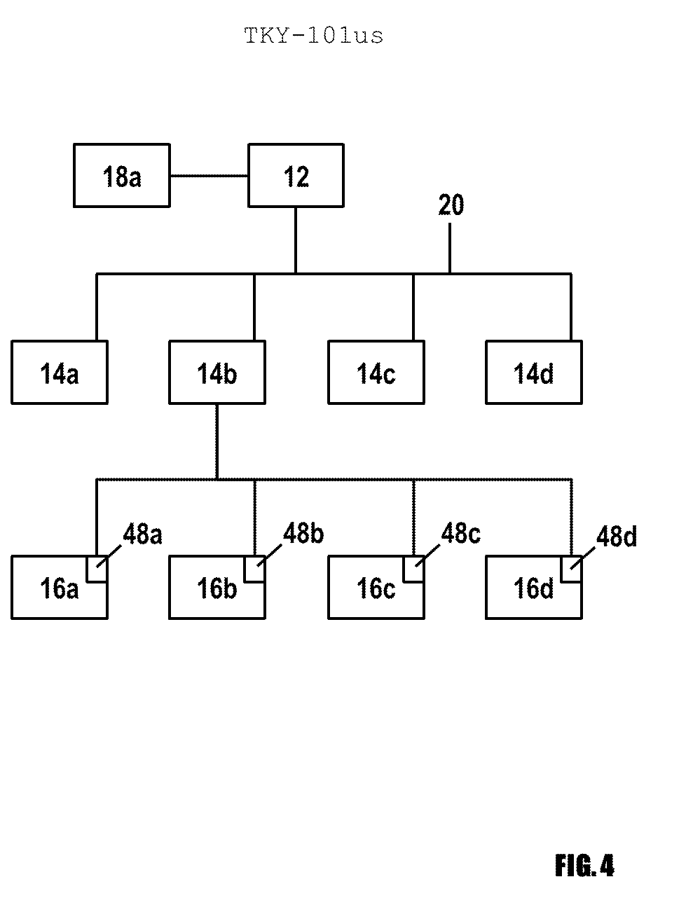

FIG. 4 illustrates how the healthcare center 12 will communicate through the network 20 with the user's health insurance company 14b from which the user 18a receives coverage. Healthcare center 12 queries the user's health insurance company to determine the pricing 48a, 48b, 48c, 48d of the medical procedure that the user 18a requires at each of the healthcare providers 16a-16d, respectively, that are within the specified geographical range as designated by the user. To determine the pricing for the medical procedure desired by the user 18a at each of the healthcare providers 16a-16d, the healthcare center 12 will typically interface with a server at the user's health insurance company 14b and query the database for a listing of real-time healthcare costs for the desired procedure at each of the of the healthcare providers 16a-16d. The server at the users health insurance company 14b may include on a database, the members previous health care claims, health plan detail and member benefits status, and previous claim adjudication.

In addition to the direct cost of the medical procedure, the healthcare center 12 will also identify any additional services or medical procedures that are necessarily performed together with the medical procedure selected by the user 18a. The healthcare center 12 will obtain a predetermined list of any additional services or medical procedures from the member's health insurance company that need to be bundled with the member's medical procedure. For example, the pricing 48a, 48b, 48c, 48d of the procedure may not include the outpatient facility charge, the physician charge, the anesthesiology charges, diagnostic tests, the units of anesthesia, miscellaneous expenses, and assistant surgeon charges needed to determine the actual full cost of the medical procedure for the member 18a.

Further, in finding the pricing of the medical procedure at the various healthcare providers 16a-16d, the healthcare center 12 may access applicable physician and facility-specific contract rates that have been negotiated by the user's health insurance company 14b. The healthcare center's server can also accesses member's specific health plan insurer 14b to consider the details of the member's health plan and the member's benefits status to incorporate member-specific benefits information, including remaining levels of member's plan year deductible, out-of-pocket plan year maximum, and coinsurance information. To carry on with the pricing of the medical procedure, the healthcare center 12 further accesses the member's health plan parameters from the health plan detail and member benefits status database, including the user's 18a active status with their specific health plan, a list of the type of medical services and procedures that are covered and/or excluded from their health plan coverage, whether the member's health insurance company 14b is considered in or out-of-network with e member's health plan, existence of applicable limits on the maximum number (or maximum covered dollar amount) of particular type of medical services or procedures that are covered under the plan during the plan year or as a lifetime maximum, patient's copayment for physician visits, and any other parameters.

Once the list of potential healthcare providers 16a-16d, along with the pricing for each has been provided to the user 18a, the user selects one of the listed healthcare providers, such as 16b. If the selected provider is less expensive than the healthcare provider 16a which they were originally planning to use, the healthcare center 12 will instruct the selected provider of this information. Then, the selected provider 16b will order the user's medical record and any other relevant information from the healthcare provider 16a which they were originally planning to use. Further, the selected healthcare provider 16b can set up an appointment for the user 18a to be seen by the appropriate specialist for evaluation and booking of the desired medical procedure.

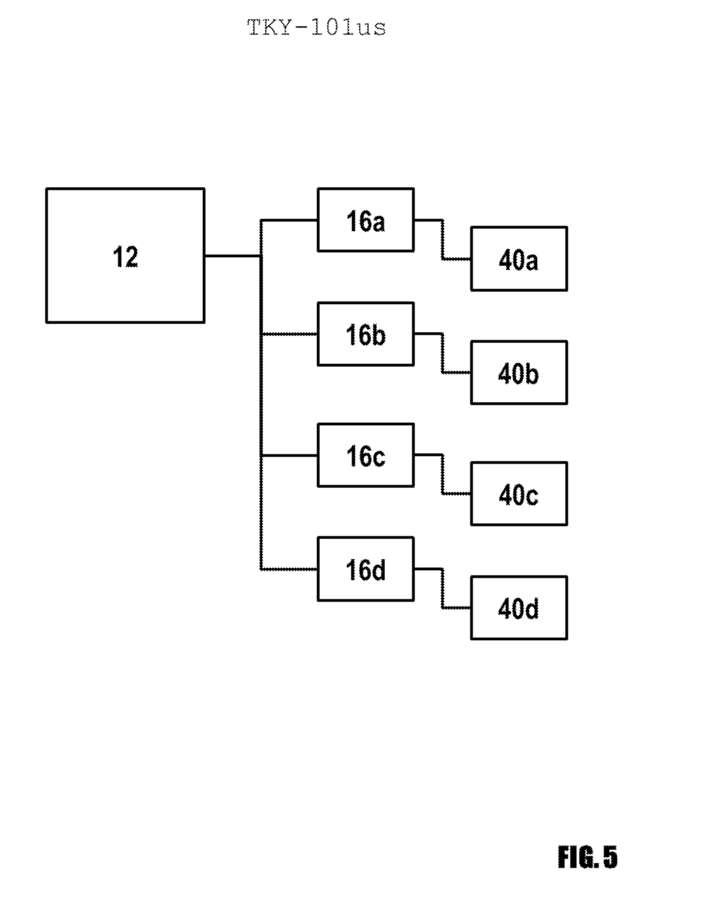

FIG. 5 illustrates the interaction and communication between the healthcare center's server and the healthcare providers 16a-16d. The healthcare providers 16a-16d includes any health care practitioner or institution that delivers health care to a user 18a ire need of healthcare services. A healthcare provider 16a-16d may be a healthcare practitioner which includes, but is not limited to, a dentist, an optometrist, a psychologist, a physician, or a doctor. A healthcare provider 16a-16d may also be a healthcare institution such as, but not limited to, a hospital, an assisted living center, a retirement home, a rehabilitation center, a nursing home, a group home, a clinic, an extended care center, or a home care provider.

In response to the user's 18a selection of a healthcare provider 16a for a specific medical procedure based on the pricing information received from the health insurance company 14b, healthcare center 12 communicates with healthcare provider 16a through data network 20 to set up appointments and as needed. It should be noted that healthcare center's server can communicate with other healthcare providers 16b-16d through data network 20 within a specified geographical range. Typically, the server 13 at healthcare center 12 connects through data network 20 with the servers 40a, 40b, 40c, 40d (40a-40d) of the healthcare providers 16a-16d, respectively. The various specific requirements of the user 18a such as their gender and age will be sent to the selected healthcare provider 16a. Also, the healthcare center 12 may verify that the healthcare provider 16a is available to complete the procedure in the window of potential dates that the user 18a is available. If available, the healthcare center 12 will inquire as to whether there are any patient reviews and other quality assurance data 17 regarding the quality of service at the potential healthcare providers 16a-16d. An appointment will be arranged for the user 18a to be seen by the appropriate specialist for evaluation and booking of the desired medical procedure.

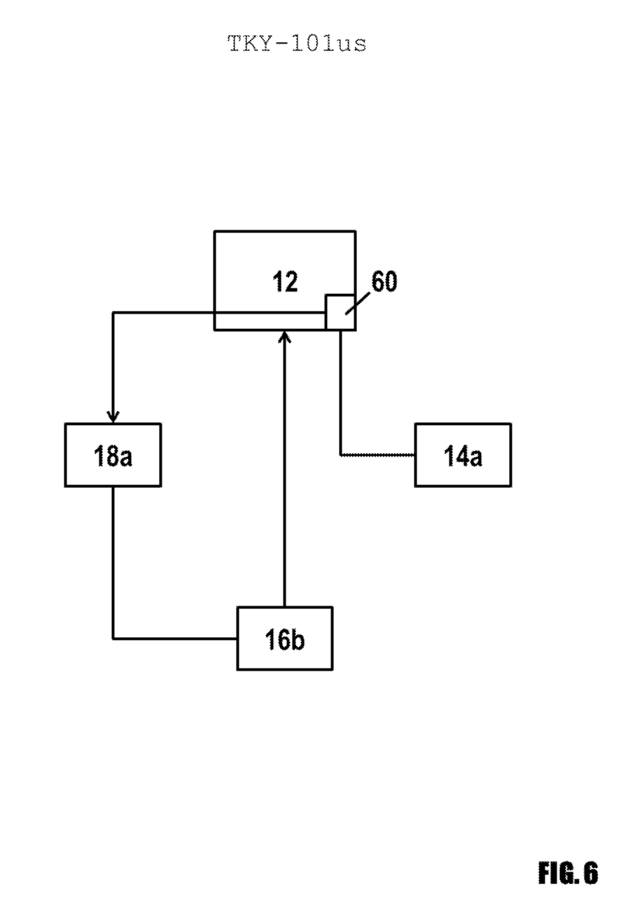

FIG. 6 illustrates the manner in which the healthcare center 12 operates to distribute the incentivized savings between the user 18a, the user's health insurance company 14a, and the healthcare center. When the user 18a selects a healthcare provider 16b, the difference in price 60 between the healthcare provider 16a at which the user is initially planning to have the medical procedure performed and the selected healthcare provider where the user finally decides to have the medical procedure performed. This price difference is divided between the user 18a, the user's health insurance company 14a, and the healthcare center 12. The way that the price difference 60 is divided may vary and be adjustable.

For example, the split may be 50% to the user 18a, 25% to the user's health insurance company 14a, and 25% to the healthcare center 12. Then, if the price difference 60 between the healthcare provider 16a at which the user is initially planning to have the medical procedure performed and healthcare provider at which selected healthcare provider where the user finally decides to have the medical procedure performed is $10,000, the user 18a can receive $5,000, the user's health insurance company 14a can receive $2,500, and the healthcare center 12 receives $2,500. Alternatively, the split may be 33% to the user 18a, 33% to the user's health insurance company 14a, and 33% to the healthcare center 12. In another example, if the price difference 60 between the most expensive healthcare option and the cheapest healthcare option is $9,999, the user 18a can receive $3,333, the user's health insurance company 14a receives or at least gains $3,333, and the healthcare center 12 receives $3,333.

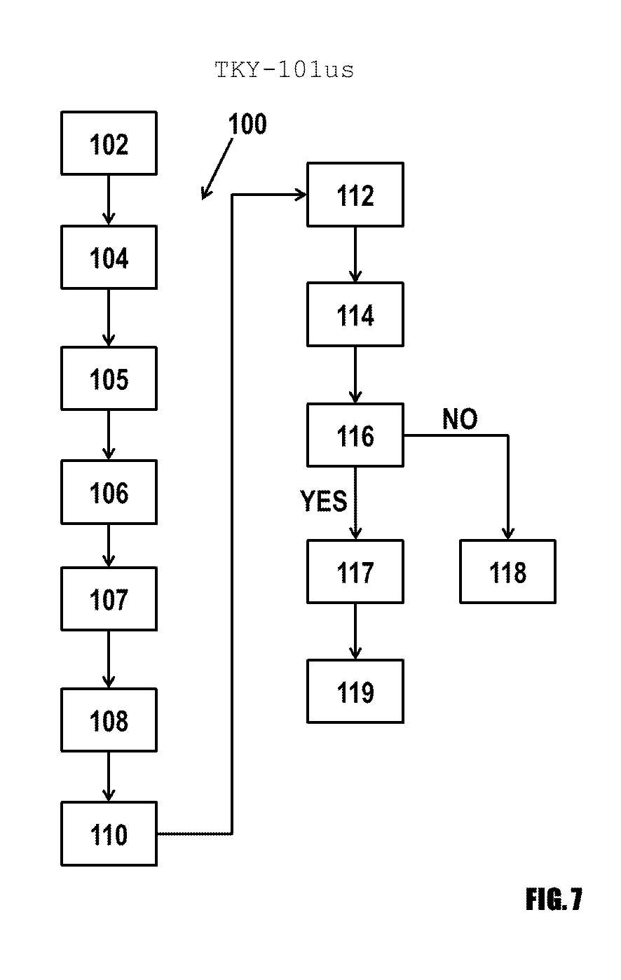

FIG. 7 illustrates the method 100 for incentivizing the use of inexpensive health care utilizing the improved health care system 10 (see FIG. 1). A healthcare center 102 is interconnected with a plurality of health insurance companies, a plurality of healthcare providers, and a plurality of users via servers and a data communication network.

In general terms, the method 100 includes step 102 of a user communicating to the healthcare center regarding a desired medical procedure at a healthcare provider where the user initially plans to have the medical procedure performed. In step 104, the healthcare center queries the data base of the user's health insurance company 105. In step 106, the healthcare center will generate a computerized list of a plurality of healthcare providers within a selected geographical area that are able to provide the medical procedure and the cost for the desired medical procedure at a cost less than the cost for the medical procedure at the healthcare provider where the user initially planned to have the medical procedure performed. In step 108, the healthcare center's server will access quality assurance data to assess the quality level for performing the medical procedure at each of the listed healthcare providers assure that the user will receive an adequate level of care at each healthcare provider. In step 110, the healthcare center will provide the user with the computerized list of potential to the user providers that are able to provide the medical procedure and the cost for the desired medical procedure at a cost less than the cost for the medical procedure at the healthcare provider where the user initially planned to have the medical procedure performed along with the quality assurance data for each and the monetary incentives to the user for selecting each of the listed healthcare providers. In step 112, the user will upload the choice of healthcare provider to the healthcare center's server. In step 114, the healthcare center will contact the healthcare provider that the user has selected, to set up a medical appointment for the user. The selected healthcare provider can arrange to have any pertinent information, such as medical records from the healthcare provider where the user initially planned to have the medical procedure performed. In step 116, if the selected healthcare provider has a monetary incentive, the distribution of the incentivized savings between the user, the health insurance company, and the healthcare center is determined in step 117. If there is no monetary incentive for the selected healthcare provider, the health insurance company and the user are so advised in step 118. In the case where there is a distribution of the incentivized savings, the health insurance company will send the amount of the distribution to the healthcare center and the user in step 119. This distribution typically occurs when the health insurance company pays the healthcare provider for their services subsequent to the medical procedure being completed.

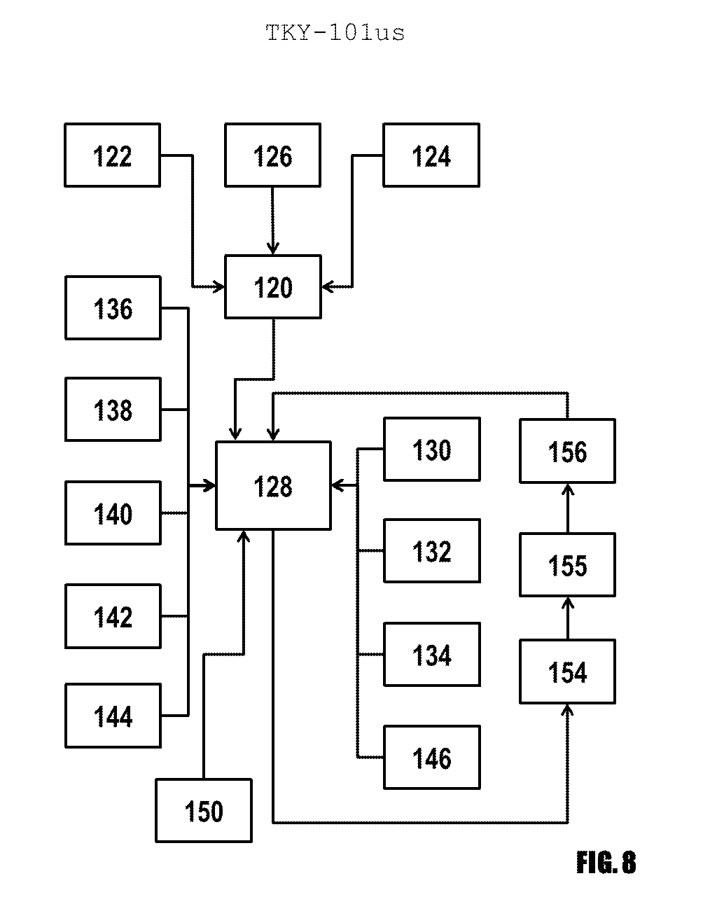

FIG. 8 illustrates a view of the steps by which the user interacts with the healthcare center, via a website or a mobile app. It is within the terms of the invention for the user to contact the health service by phone and complete the steps needed to select a health care center as discussed herein. In step 120, a user logs on to the website or the app. If it is for the first time, the user may be asked to create an account, including the steps of creating a unique user name 122, such as an E-mail address, and a password 124, which a log-in module within the website or app can require for secure access. It is within the terms of the embodiment that there is a step 126, in which the new user must accept a set of terms and conditions and/or complete a member profile before completing registration.

In step 128, the user creates a profile within their account on the website or the app, including the steps of entering their physical features 130, such as height and weight, pertinent insurance information 132, their geographical area 134, their medical record 136, the medications that they are currently taking 138, any relevant family health issues 140, a window of potential dates for the medical procedure to take place 142, their health insurance company 144 and any other significant information. In step 146, the user will enter information directly relating to the particular surgical procedure they desire.

In step 150, the healthcare center uploads to the website or the app a computerized listing of healthcare providers in a specified geographical area, such as a 50 mile radius of the user's location, quality assurance data for each of the listed healthcare providers that offer the same medical procedure for a lower price than the user's original provider while maintaining similar patient outcomes and satisfaction and the monetary incentive or rebate associated with each of the listed healthcare providers. The amount of the monetary incentive or rebate will be related to the cost savings to the health insurance company if the user selects a lower cost healthcare provider compared to the original healthcare provider. The computerized list can be ranked according to price, geographical proximity, and quality assurance. In step 154, if the user selects a lower cost healthcare provider and in response to the selection, the healthcare center will notify the healthcare provider in step 155 that the user has selected them and arrange to have a medical appointment for the user. At that time, the selected healthcare provider can arrange to have any pertinent information, such as medical records from the healthcare provider where the user initially planned to have the medical procedure performed. Then in step 156, the healthcare center will receive information as to the date and time of the appointment and the appropriate specialist for evaluation and booking of the medical procedure and will post the appointment date and time from the healthcare provider on the website or the app.

It's also within the scope of the preferred embodiments to provide a method and system for incentivizing the use of inexpensive health care including receiving an inquiry about a medical procedure desired by a user covered by a health insurance company to a healthcare center's server. Next, the data base of the user's health insurance company's server is queried for a plurality of healthcare providers able to provide the medical procedure and the cost of the medical procedure at each of the plurality of healthcare providers. A computerized list of the plurality of healthcare providers is generated to provide the medical procedure and the cost of the medical procedure by the healthcare center's server. Then, a plurality of monetary incentives for each of the plurality of healthcare providers is computed and added to the computerized list. The user is provided with the computerized list of the plurality of healthcare providers able to provide the medical procedure and a user monetary incentive for selecting each of the plurality of healthcare providers.

The data base of the user's health insurance company's server is queried for the plurality of healthcare providers within a selected geographic area.

The computerized list of the plurality of healthcare providers a selected healthcare provider by the user is uploaded to the healthcare center's server.

The user and healthcare center are each compensated with a monetary incentive for selecting the selected healthcare provider having a lower cost than other healthcare providers on the computerized listed.

Quality assurance data can be collected on the healthcare center's server for performing the medical procedure by each of the plurality of the healthcare providers on the computerized list.

Further, the user is provided with the computerized list of the plurality of the healthcare providers able to provide the medical procedure, the monetary incentive for selecting each particular provider, and the quality assurance data for each of the plurality of the healthcare providers.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A method for incentivizing the use of inexpensive health care, comprising:
receiving an inquiry about a medical procedure desired by a user at a first healthcare provider covered by a health insurance company to a healthcare center's server;
querying the database of the user's health insurance company's server for a plurality of healthcare providers including the first healthcare provider able to provide the medical procedure and the cost of the medical procedure at each of the plurality of healthcare providers;
generating a computerized list of the plurality of healthcare providers able to provide the medical procedure at a cost less than the first healthcare provider by the healthcare center's server;
computing a monetary incentive on the healthcare center's server for selecting any of the healthcare providers on the computerized list able to provide the medical procedure at a cost less than the first healthcare provider; and
providing the user with the computerized list of the plurality of the healthcare providers able to provide the medical procedure at a cost less than the first healthcare provider and the monetary incentive for selecting each particular healthcare provider.

2. The method of claim 1 including querying the data base of the user's health insurance company's server for the plurality of healthcare providers within a selected geographic area.

3. The method of claim 1 including uploading a selected healthcare provider to the healthcare center's server by the user.

4. The method of claim 1 including compensating the user with the monetary incentive for selecting one of the listed healthcare provider having a lower cost than the most expensive healthcare provider on the computerized listed for the medical procedure.

5. The method of claim 1 including compensating the healthcare center with the monetary incentive for the user selecting a listed healthcare provider having a lower cost than the first healthcare provider on the computerized listed for the medical procedure.

6. The method of claim 1 including:
collecting quality assurance data on the healthcare center's server for performing the medical procedure by each of the plurality of the healthcare providers on the computerized list.

7. The method of claim 6 including:
providing the user with the computerized list of the plurality of the healthcare providers able to provide the medical procedure, the monetary incentive for selecting each particular provider, and the quality assurance data for each of the plurality of the healthcare providers.

8. The method of claim 1 including uploading the computerized listing on a website or a mobile application.

9. A system for incentivizing the use of inexpensive health care, comprising:
a healthcare center's server operative to receive an inquiry about a medical procedure desired by a user at a first healthcare provider covered by a health insurance company;
the healthcare center's server operative to querying the database of the user's health insurance company's server for a plurality of healthcare providers including the first healthcare provider able to provide the medical procedure and the cost of the medical procedure at each of the plurality of healthcare providers;
the healthcare center's server operative to generate a computerized list of the plurality of healthcare providers able to provide the medical procedure at a cost less than the first healthcare provider;
the healthcare center's server operative to compute a monetary incentive on the healthcare center's server for selecting each of the plurality of healthcare providers on the computerized list able to provide the medical procedure at a cost less than the first healthcare provider; and
the healthcare center's server operative to provide the user with the computerized list of the plurality of healthcare providers able to provide the medical procedure at a cost less than the first healthcare provider and the monetary incentive for selecting each of the plurality of healthcare providers.

10. The system of claim 9 including the healthcare center's server operative to query the data base of the user's health insurance company's server for the plurality of healthcare providers within a selected geographic area.

11. The system of claim 10 including:
the healthcare center's server operative to collect quality assurance data for performing the medical procedure by each of the plurality of the healthcare providers on the computerized list.

12. The system of claim 11 including:
the healthcare center's server operative to provide the user with the computerized list of the plurality of the healthcare providers able to provide the medical procedure, the monetary incentive for selecting each particular provider, and the quality assurance data for each of the plurality of the healthcare providers.

13. The system of claim 12 including:
the healthcare center's server operative to upload the computerized listing on a website or a mobile application.

14. A non-transitory program storage device capable by a machine, tangibly embodying a program of instructions executable by the machine to perform a method of incentivizing the use of inexpensive health care, comprising:
receiving an inquiry about a medical procedure desired by a user at a first healthcare provider covered by a health insurance company to a healthcare center's server;
querying the database of the user's health insurance company's server for a plurality of healthcare providers including the first healthcare provider able to provide the medical procedure and the cost of the medical procedure at each of the plurality of healthcare providers;
generating a computerized list of the plurality of healthcare providers able to provide the medical procedure at a cost less than the first healthcare provider by the healthcare center's server;
computing a monetary incentive on the healthcare center's server for selecting each of the healthcare providers on the computerized list able to provide the medical procedure at a cost less than the first healthcare provider; and
providing the user with the computerized list of the plurality of the healthcare providers able to provide the medical procedure at a cost less than the first healthcare provider and the monetary incentive for selecting each particular healthcare provider.

15. A method for incentivizing the use of inexpensive health care, comprising:
receiving an inquiry about a medical procedure desired by a user covered by a health insurance company to a healthcare center's server;
querying the data base of the user's health insurance company's server for a plurality of healthcare providers able to provide the medical procedure and the cost of the medical procedure at each of the plurality of healthcare providers;
generating a computerized list of the plurality of healthcare providers able to provide the medical procedure and the cost of the medical procedure by the healthcare center's server;
computing a plurality of monetary incentives for each of the plurality of healthcare providers on the computerized list; and
providing the user with the computerized list of the plurality of healthcare providers able to provide the medical procedure and a user monetary incentive for selecting each of the plurality of healthcare providers.

16. The method of claim 15 including querying the data base of the user's health insurance company's server for the plurality of healthcare providers within a selected geographic area.

17. The method of claim 15 including uploading from the computerized list of the plurality of healthcare providers a selected healthcare provider by the user to the healthcare center's server.

18. The method of claim 15 including compensating the user with a monetary incentive for selecting the selected healthcare provider having a lower cost than other healthcare providers on the computerized listed.

19. The method of claim 15 including compensating the healthcare center with the monetary incentive for the user selecting a listed healthcare provider having a lower cost than the most expensive healthcare provider on the computerized listed for the medical procedure.

20. The method of claim 15 including:
collecting quality assurance data on the healthcare center's server for performing the medical procedure by each of the plurality of the healthcare providers on the computerized list.

21. The method of claim 15 including:
providing the user with the computerized list of the plurality of the healthcare providers able to provide the medical procedure, the monetary incentive for selecting each particular provider, and the quality assurance data for each of the plurality of the healthcare providers.
